(19) United States
(12) Patent Application Publication
(10) Pub. No.: US 2025/0367583 A1
(43) Pub. Date: Dec. 4, 2025

(54) FILTER APPARATUS AND CLOTHES TREATING APPARATUS HAVING SAME

(71) Applicant: SAMSUNG ELECTRONICS CO., LTD., Suwon-si (KR)

(72) Inventors: Youngjin CHO, Suwon-si (KR); Dongpil SEO, Suwon-si (KR); Jaebok LEE, Suwon-si (KR); Kanghyun LEE, Suwon-si (KR); Jaewan HONG, Suwon-si (KR)

(73) Assignee: SAMSUNG ELECTRONICS CO., LTD., Suwon-si (KR)

(21) Appl. No.: 19/302,903

(22) Filed: Aug. 18, 2025

Related U.S. Application Data
(63) Continuation of application No. PCT/KR2024/095279, filed on Feb. 16, 2024.

(30) Foreign Application Priority Data
Apr. 3, 2023 (KR) 10-2023-0043791

(51) Int. Cl. B01D 35/16; D06F 39/08; D06F 39/10

(52) U.S. Cl. CPC B01D 35/16; D06F 39/083; D06F 39/10

(57) ABSTRACT

A filter apparatus, to be disposed outside a washing machine, connectable to a drain device of the washing machine, includes a filter case, a filter coupleable to and decoupleable from the filter case, and a filter cleaning device configured to clean the filter. The filter cleaning device includes a cleaning driving device mountable in the filter case, and a cleaning member couplable to and decoupleable from the cleaning driving device, the cleaning member including a portion configured to be deformable while the cleaning member is decoupled from the cleaning driving device.

### CROSS-REFERENCE TO RELATED APPLICATION

This application is a continuation application is a continuation application, under 35 U.S.C. § 111 (a), of international application No. PCT/KR2024/095279, filed Feb. 16, 2024, which claims priority under 35 U. S. C. § 119 to Korean Patent Application No. 10-2023-0043791, filed Apr. 3, 2023, the disclosures of which are incorporated herein by reference in their entireties.

### TECHNICAL FIELD

The present disclosure relates to a filter apparatus connectable to a washing machine and clothes treating apparatus having the filter apparatus.

### BACKGROUND ART

A washing machine is an apparatus for washing laundry put to the inside of the tub through friction by stirring the laundry, water, and a detergent together by using a driving force of a driving motor.

Operations that are performed by the washing machine include, regardless of the type of the washing machine, a washing operation for washing laundry put into the tub by supplying a detergent and water to the tub and rotating the drum, a rinsing operation for rinsing the laundry by supplying water to the tub and rotating the drum, and a dehydrating operation for dehydrating water of the laundry by discharging water from the tub and rotating the drum.

The washing machine includes a drain device configured to discharge water stored in the tub to the outside of the washing machine while performing the washing operation, the rinsing operation, and/or the dehydrating operation. The drain device is configured to again discharge water discharged from the tub to the tub while performing the washing operation and/or the rinsing operation.

### DISCLOSURE

### Technical Problem

An aspect of the disclosure provides a filter apparatus and a clothes treating apparatus having the filter apparatus that is easy to manage.

An aspect of the disclosure provides a filter apparatus and a clothes treating apparatus having the filter apparatus capable of increasing a filter replacement cycle.

Technical objects of the disclosure are not limited to those described above, and other technical objects not described herein will also be clearly understood by a person who has a common knowledge in the technical field to which the disclosure pertains from the following detailed description.

### Technical Solution

According to an embodiment of the disclosure, a filter apparatus positionable outside a washing machine and connectable to a drain device of the washing machine, the filter apparatus comprises a filter case, a filter coupleable to and decoupleable from the filter case, and a filter cleaning device configured to clean the filter. The filter cleaning device includes a cleaning driving device mountable in the filter case, and a cleaning member couplable to and decoupleable from the cleaning driving device, the cleaning member including a portion configured to be deformable while the cleaning member is decoupled from the cleaning driving device.

According to an embodiment of the disclosure, a clothes treating apparatus includes a washing machine including a washing machine housing, a tub to be provided inside the washing machine housing, a drain device configured to discharge water from the tub to outside of the washing machine housing, and a filter apparatus to be disposed outside the washing machine housing and connectable to the drain device. The filter apparatus comprises a filter case, a filter coupleable to and decoupleable from the filter case, and a filter cleaning device configured to clean the filter. The filter cleaning device comprises a cleaning driving device mountable in the filter case, a blade bracket couplable to and decoupleable from the cleaning driving device, the blade bracket including a portion that is deformable while the blade bracket is decoupled from the cleaning driving device, and a blade detachably couplable to the blade bracket.

### DESCRIPTION OF DRAWINGS

FIG. 1 shows a clothes treating apparatus according to an embodiment of the disclosure.

FIG. 2 shows a cross section of a washing machine shown in FIG. 1 according to an embodiment of the disclosure.

FIG. 3 is a control block diagram of a washing machine according to an embodiment of the disclosure.

FIG. 4 shows a clothes treating apparatus according to an embodiment of the disclosure.

FIG. 5 shows a cross section of a washing machine shown in FIG. 1 according to an embodiment of the disclosure.

FIG. 6 shows an inside of a filter apparatus shown in FIG. 1 and FIG. 4 according to an embodiment of the disclosure.

FIG. 7 is an exploded view of the filter apparatus shown in FIG. 6 according to an embodiment of the disclosure.

FIG. 8 shows the filter apparatus shown in FIG. 7 in a different direction from FIG. 7 according to an embodiment of the disclosure.

FIG. 9 is a control block diagram of the filter apparatus according to an embodiment.

FIG. 10 shows a cross section of some components of the filter apparatus shown in FIG. 6 according to an embodiment of the disclosure.

FIG. 11 shows a flow of water flowing into a filter case shown in FIG. 10 and then being discharged after passing through the filter according to an embodiment of the disclosure.

FIG. 12 shows a state in which foreign substances inside the filter are collected by the filter cleaning device shown in FIG. 10 according to an embodiment of the disclosure.

FIG. 13 shows an exploded view of the cleaning member of the filter cleaning device shown in FIGS. 7 and 8 according to an embodiment of the disclosure.

FIG. 14 shows a state in which the filter is separated from the filter case to detach the blade from the filter cleaning device shown in FIG. 10 according to an embodiment of the disclosure.

FIG. 15 shows an enlarged view of a portion A shown in FIG. 14 according to an embodiment of the disclosure.

FIG. 16 shows a cross-sectional view taken along line B-B′ of FIG. 15 according to an embodiment of the disclosure.

FIG. 17 shows a state in which the deformable portion of the cleaning member shown in FIG. 15 is deformed according to an embodiment of the disclosure.

FIG. 18 shows a cross-sectional view taken along line C-C′ of FIG. 17 according to an embodiment of the disclosure.

FIG. 19 shows separation of the blade bracket from the motor shaft shown in FIG. 18 according to an embodiment of the disclosure.

FIG. 20 shows removal of the blade from the filter case shown in FIG. 14 according to an embodiment of the disclosure.

FIG. 21 shows a filter cleaning device according to an embodiment.

FIG. 22 shows a cross-sectional view of the filter cleaning device shown in FIG. 21 according to an embodiment of the disclosure.

FIG. 23 shows a filter cleaning device according to an embodiment.

FIG. 24 shows a cross-sectional view of the filter cleaning device shown in FIG. 23 according to an embodiment of the disclosure.

FIG. 25 shows a filter cleaning device according to an embodiment.

FIG. 26 shows a cross-sectional view of the filter cleaning device shown in FIG. 25 according to an embodiment of the disclosure.

### MODE FOR INVENTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

The term “and/or” includes any and all combinations of one or more of associated listed items.

As used herein, such terms as “1st” and “2nd,” or “first” and “second” may be used to simply distinguish a corresponding component from another, and does not limit the components in other aspect (for example, importance or order).

It is to be understood that if a certain component (for example, a first component) is referred to, with or without the term “operatively” or “communicatively”, as “coupled with,” “coupled to,” “connected with,” or “connected to” another component (for example, a second component), it means that the component may be coupled with the other component directly (for example, wiredly), wirelessly, or via a third element.

It is to be understood that the terms such as “including” or “having,” etc., are intended to indicate the existence of the features, numbers, steps, operations, components, parts, or combinations thereof disclosed in the specification, and are not intended to preclude the possibility that one or more other features, numbers, steps, operations, components, parts, or combinations thereof may exist or may be added.

It is to be understood that if a certain component is referred to as being “coupled with,” “coupled to,” “supported on” or “in contact with” another component, it means that the component may be coupled with the other component directly or indirectly via a third component.

It will also be understood that when a certain component is referred to as being “on” or “over” another component, it can be directly on the other component or intervening components may also be present.

A washing machine, according to various embodiments, may perform washing, rinsing, draining, and dehydrating operations. A washing machine may also be a drying combination washing machine capable of performing a drying operation on the dehydrated laundry. A washing machine may be an example of a clothes treating apparatus. The clothes treating apparatus is a concept that includes a device for washing clothes (objects to be washed or dried), a device for drying clothes, and a device capable of washing and drying clothes.

The washing machine according to various embodiments of the disclosure may include a top-loading washing machine, wherein an inlet through which laundry is put into the top-loading washing machine is provided upward, or a front-loading washing machine, wherein an inlet through which laundry is put into the front-loading washing machine is provided forward. The washing machine according to various embodiments of the disclosure may include another loading type of washing machine, except for the top-loading washing machine and the front-loading washing machine.

The top-loading washing machine may wash laundry by using water streams generated by a rotating body such as a pulsator. The front-loading washing machine may wash laundry by rotating a drum to repeatedly raise and drop the laundry. The front-loading washing machine may include a lift for raising laundry. The front-loading washing machine may include a drying combination washing machine capable of drying laundry stored in a drum. The drying combination washing machine may include a heating device for high-temperature air. The drying combination washing machine may further include a condensing device for dry air. For example, the drying combination washing machine may include a heat pump. The washing machine according to various embodiments of the disclosure may include a washing machine using another washing method, except for a washing machine using the above-described washing method.

Hereinafter, a washing machine according to various embodiments of the disclosure will be described in detail with reference to the accompanying drawings.

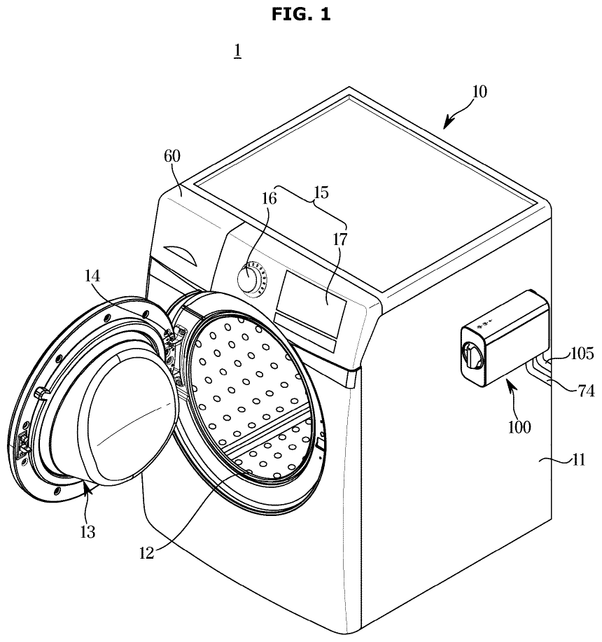

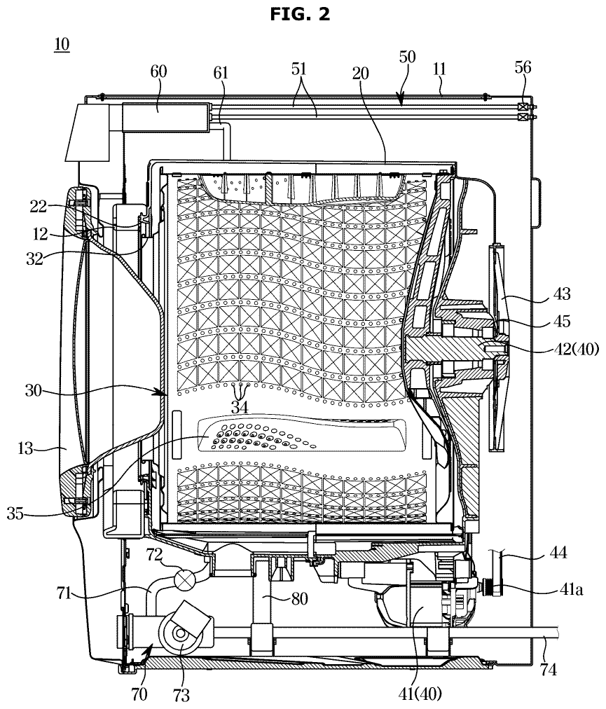

FIG. 1 shows a clothes treating apparatus according to an embodiment of the disclosure. FIG. 2 shows a cross section of a washing machine shown in FIG. 1.

Referring to FIGS. 1 and 2, a washing machine 10 of a clothes treating apparatus may include a washing machine housing 11 accommodating various components therein. The washing machine housing 11 may form an exterior of the washing machine 10. The washing machine housing 11 may have the shape of a box that is at least partially open.

The washing machine housing 11 may include a housing opening 12 for allowing an access to inside of a drum 30. The housing opening 12 may open approximately forward.

The washing machine 10 may include a door 13 for opening or closing the housing opening 12 provided in the washing machine housing 11. The door 13 may be rotatably mounted on the washing machine housing 11 by a hinge 14. At least one portion of the door 13 may be transparent or translucent to show the inside of the washing machine housing 11.

The washing machine 10 may include a tub 20 provided inside the washing machine housing 11 to store water. The tub 20 may be disposed inside the washing machine housing 11. The tub 20 may include a tub opening 22 provided to correspond to the housing opening 12. The tub opening 22 may open substantially forward. The tub 20 may be supported on an inner surface of the washing machine housing 11. The tub 20 may have a substantially cylindrical shape of which one side opens.

The tub 20 may be elastically supported from the washing machine housing 11 by a damper 80. The damper 80 may connect the tub 20 to the washing machine housing 11. While vibrations generated according to a rotation of the drum 30 are transferred to the tub 20 and/or the washing machine housing 11, the damper 80 may absorb vibration energy between the tub 20 and the washing machine housing 11 to attenuate the vibrations.

The washing machine 10 may include the drum 30 accommodating laundry. The drum 30 may be rotatably provided inside the tub 20. The drum 30 may perform washing, rinsing, and/or dehydrating while rotating inside the tub 20. The drum 30 may include a through hole 34 that connects an inside space of the drum 30 to an inside space of the tub 20. The drum 30 may have a substantially cylindrical shape of which one side opens. On an inner circumferential surface of the drum 30, at least one lifter 35 may be provided to raise and drop laundry according to a rotation of the drum 30.

The drum 30 may include a drum opening 32 corresponding to the housing opening 12 and the tub opening 22. Laundry may be put into or withdrawn from the drum 30 through the housing opening 12, the tub opening 22, and the drum opening 32.

The washing machine 10 may include a washing machine driver 40 configured to rotate the drum 30. The washing machine driver 40 may include a driving motor 41, and a rotating shaft 42 for transferring a driving force generated in the driving motor 41 to the drum 30. The rotating shaft 42 may penetrate the tub 20 and be connected to the drum 30.

The washing machine 10 may be divided into a direct drive type in which the rotating shaft 42 is directly connected to the driving motor 41 to rotate the drum 30, and an indirect drive type in which a pulley 43 is connected between the driving motor 41 and the rotating shaft 42 to drive the drum 30.

The washing machine 10 according to an embodiment may be arranged as an indirect drive type, but may also be arranged as a direct drive type, without being limited thereto.

One end of the rotating shaft 42 may be connected to the drum 30, and another end of the rotating shaft 42 may be connected to the pulley 43 to obtain a driving force from the driving motor 41. A motor pulley 41a may be formed on the rotating axis of the driving motor 41. A driving belt 44 is provided between the motor pulley 41a and the pulley 43 so that the rotating shaft 42 may be driven by the driving belt 44.

In the rear portion of the tub 20, a bearing housing 45 may be installed to rotatably support the rotating shaft 42. The bearing housing 45 may be made of an aluminum alloy and may be inserted into the rear portion of the tub 20 upon injection-molding of the tub 20.

The washing machine driver 40 may be provided to perform washing, rinsing, and/or dehydration or drying operations by rotating the drum 30 regularly or reversely.

The washing machine 10 may include a water supply device 50. The water supply device 50 may supply water to the tub 20. The water supply device 50 may be located above the tub 20. The water supply device 50 may include a water supply pipe 51, and a water supply valve 56 provided in the water supply pipe 51. The water supply pipe 51 may be connected to an external water supply source. The water supply pipe 51 may extend to a detergent supply device 60 and/or the tub 20 from the external water supply source. Water may be supplied to the tub 20 via the detergent supply device 60. Water may be supplied to the tub 20 not via the detergent supply device 60.

The water supply valve 56 may open or close the water supply pipe 51 in response to an electrical signal from a controller 90. The water supply valve 56 may allow or block supply of water from the external water supply source to the tub 20. The water supply valve 56 may include, for example, a solenoid valve that is opened or closed in response to an electrical signal.

The washing machine 10 may include the detergent supply device 60 configured to supply a detergent to the tub 20. The detergent supply device 60 may supply a detergent to the inside of the tub 20 during a water supply process. Water supplied through the water supply pipe 51 may be mixed with a detergent via the detergent supply device 60. The water mixed with the detergent may be supplied to the inside of the tub 20. The detergent may include a conditioner for dryer, a deodorant, a sterilizer, or an air freshener, as well as a washing detergent. The detergent supply device 60 may be connected to the tub 20 through a connection pipe 61.

The washing machine 10 may include a drain device 70. The drain device 70 may be configured to discharge water accommodated in the tub 20 to outside. The drain device 70 may include a drain pump 73 for discharging water from the tub 20 to the outside of the washing machine housing 11, a connection hose 71 connecting the tub 20 and the drain pump 73 so that water inside the tub 20 flows into the drain pump 73, and a drain hose 74 for guiding water pumped by the drain pump 73 to the outside of the washing machine housing 11. The drain device 70 may include a drain valve 72 provided on the connection hose 71 to open and close the connection hose 71.

The washing machine 10 may provide a user interface device 15 for interaction between the user and the washing machine 10.

The washing machine 10 may include at least one user interface device 15. The user interface device 15 may include at least one input interface 16 and at least one output interface 17.

At least one input interface 16 may convert sensory information received from a user into an electrical signal.

At least one input interface 16 may include a power button, an operation button, a course selection dial (or a course selection button), and a washing/rinsing/dehydrating setting button. At least one input interface 16 may include, for example, a tact switch, a push switch, a slide switch, a toggle switch, a micro switch, a touch switch, a touch pad, a touch screen, a jog dial, and/or microphone, etc.

At least one output interface 17 may transmit various data related to the operation of the washing machine 10 to the user by generating sensory information.

For example, at least one output interface 17 may transmit information related to a washing course, an operating time of the washing machine 10, and washing setting/rinsing setting/spinning setting to the user. Information on the operation of the washing machine 10 may be output through a screen, indicator, or voice. At least one output interface 17 may include, for example, a Liquid Crystal Display (LCD) panel, a Light Emitting Diode (LED) panel, a speaker, etc.

The clothes treating apparatus 1 may include a filter apparatus 100 provided to be connectable to the drain device 70 of the washing machine 10. The filter apparatus 100 may be disposed outside the washing machine 10. The filter apparatus 100 may be provided to filter foreign substances from water discharged from the washing machine 10. The filter apparatus 100 may be provided to filter foreign substances having a size smaller than that of foreign substances filterable by the washing machine 10. For example, the filter apparatus 100 may be provided to filter foreign substances having a size smaller than that of foreign substances filterable by the drain device 70 of the washing machine 10.

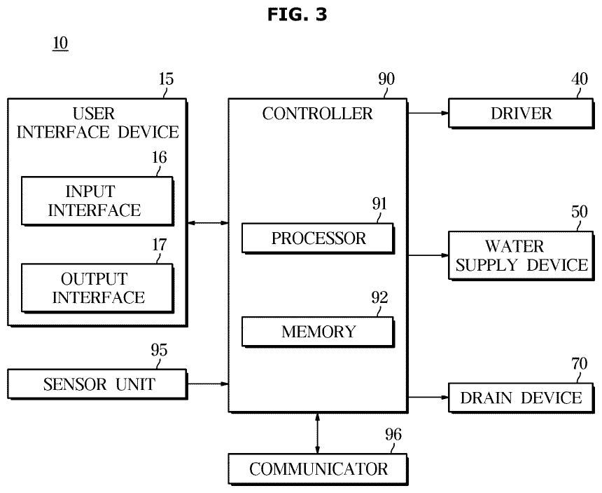

FIG. 3 is a control block diagram of a washing machine according to an embodiment of the disclosure.

In an embodiment, the washing machine 10 may include a user interface device 15, a driver 40, a water supply device 50, a drain device 70, a sensor unit 95, a communicator 96, and a controller 90.

The user interface device 15 may provide a user interface for interacting with the user and the washing machine 10.

The user interface device 15 may include at least one input interface 16 and at least one output interface 17.

The at least one input interface 16 may convert sensory information received from the user into electrical signals.

At least one input interface 16 may include a power button, an operation button, a course selection dial (or a course selection button), and a washing/rinsing/dehydrating setting button. At least one input interface 16 may include, for example, a tact switch, a push switch, a slide switch, a toggle switch, a micro switch, a touch switch, a touch pad, a touch screen, a jog dial, and/or microphone, etc.

At least one output interface 17 may transmit various data related to the operation of the washing machine 10 to the user by generating sensory information.

For example, at least one output interface 17 may transmit information related to a washing course, an operating time of the washing machine 10, and washing setting/rinsing setting/spinning setting to the user. Information on the operation of the washing machine 10 may be output through a screen, indicator, or voice. At least one output interface 17 may include, for example, a Liquid Crystal Display (LCD) panel, a Light Emitting Diode (LED) panel, a speaker, etc.

The driver 40 may include the driving motor 41 that provides driving force to rotate the drum 30. The driver 40 may operate based on a control signal from the controller 90.

The water supply device 50 may include the water supply valve 56 for opening and closing a water supply pipe 51 extending from an external water source to the detergent supply device 60 and/or the tub 20. The water supply valve 56 may be opened and closed based on a control signal from the controller 90.

The drain device 70 may include the drain pump 73 for discharging water from the tub 20 to the outside of the washing machine housing 11. The drain pump 73 may operate based on a control signal of the controller 90.

The sensor unit 95 may include at least one sensor that obtains information related to the operating state of the washing machine 10.

For example, the sensor unit 95 may include at least one of a water level sensor for detecting the water level of the tub, a sensor for detecting the operating state of the driver 40, a flow sensor for detecting a flow rate flowing into the tub 20 through the water supply device 50, or a sensor for detecting an operating state of the drain device 70.

The sensor for detecting the operating state of the driver 40 may include, for example, a current sensor for measuring the driving current applied to the driving motor 41, but is not limited thereto.

The sensor for detecting the operating state of the drain device 70 may include, for example, a current sensor for measuring the driving current applied to the drain pump 73, but is not limited thereto.

The washing machine 10 may include a communicator 96 for wired and/or wireless communication with an external device.

The communicator 96 may include at least one of a short-range communicator and a long-range communicator.

The communicator 96 may transmit data to an external device (e.g. a server, user device, home appliance, and/or filter apparatus 100) or receive data from the external device. For example, the communicator 96 may establish communication with a server and/or user device and/or home appliance and transmit/receive various data.

For this, the communicator 96 may establish a direct (wired) communication channel or a wireless communication channel with an external electronic device (for example, a server, a user terminal, and/or a home appliance), and support communication through the established communication channel. According to an embodiment of the disclosure, the communicator 96 may include a wireless communicator (for example, a cellular communicator, a short-range wireless communicator, or a global navigation satellite system (GNSS) communicator), or a wired communicator (for example, a local area network (LAN) communicator or a power line communicator). A corresponding communicator among the communicators may communicate with an external electronic device through a first network (for example, a short-range communication network, such as Bluetooth, wireless fidelity (WiFi) direct, or infrared data association (IrDA)) or a second network (for example, a telecommunication network, such as a legacy cellular network, a 5G network, a next-generation communication network, internet, or a computer network (for example, a local area network (LAN) or a wide area network (WAN)). Such various kinds of communicators may be integrated into a component (for example, a single chip) or implemented as a plurality of independent components (for example, a plurality of chips).

A short-range wireless communicator may include a Bluetooth communicator, a Bluetooth Low Energy (BLE) communicator, a near field communicator (Near Field Communicator), a WLAN (Wi-Fi) communicator, a Zigbee communicator, an infrared data association (IrDA) communicator, a Wi-Fi Direct (WFD) communicator, an ultrawideband (UWB) communicator, an Ant+ communicator, a microwave (uWave) communicator or the like, but is not limited thereto.

The remote communicator may include a communicator that performs various types of long-distance communication, and may include a mobile communication unit.

In an embodiment, the communicator may communicate with an external device such as a server, user device, or other home appliance through a nearby access point (AP). The access relay (AP) may connect a local area network (LAN) to which the washing machine 10 or user device is connected to a wide area network (WAN) to which a server is connected. The washing machine 10 or user device may be connected to the server through a wide area network (WAN). The controller 90 may control various components (e.g. the driver 40 and the water supply device 50) of the washing machine 10. The controller 90 may control various components of the washing machine 10 to perform at least one operation including water supply, washing, rinsing, and/or dehydrating according to a user input. For example, the controller 90 may control the driving motor 41 to adjust the rotational speed of the drum 30 or the water supply valve 56 of the water supply device 50 to supply water to the tub 20.

The controller 90 may include hardware such as a CPU or memory, and software such as a control program. For example, the controller 90 may include an algorithm for controlling the operation of components in the washing machine 10, at least one memory 92 that stores data in the form of a program, and at least one processor 91 that performs the above-described operation using data stored in at least one memory. The memory 92 and the processor 91 may be implemented as separate chips. The processor 91 may include one or more processor chips or may include one or more processing cores. The memory 92 may include one or more memory chips or may include one or more memory blocks. Also, the memory 92 and the processor 91 may be implemented as a single chip.

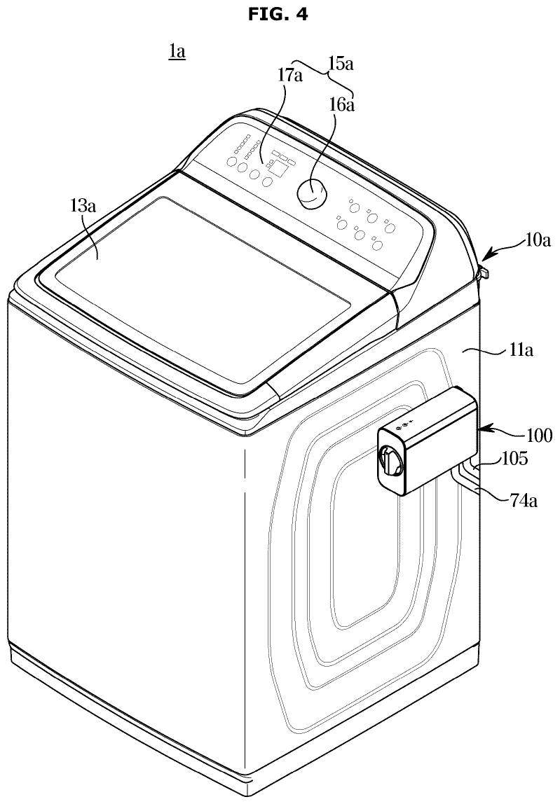

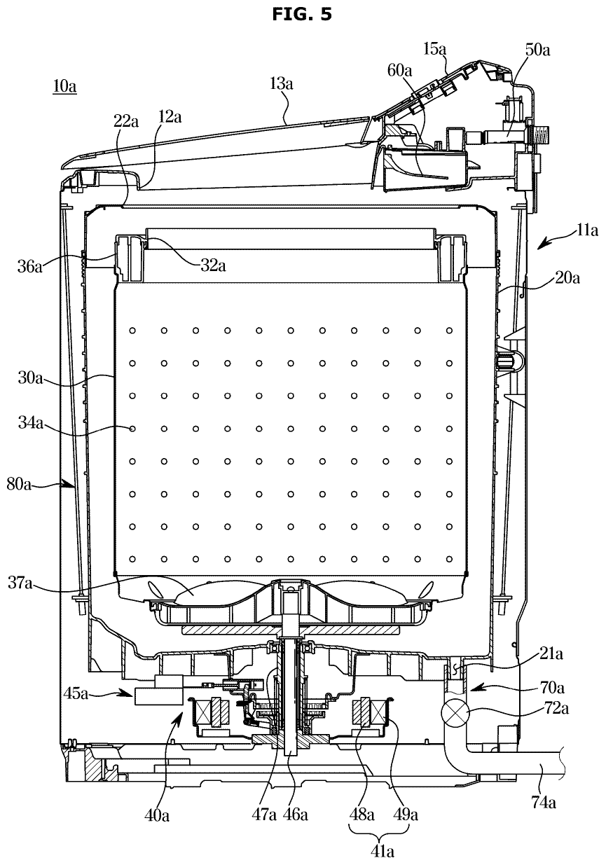

FIG. 4 shows a clothes treating apparatus according to an embodiment of the disclosure. FIG. 5 shows a cross section of a washing machine shown in FIG. 1.

As shown in FIGS. 4 and 5, the washing machine 10a of the clothes treating apparatus 1a may include a housing 11a accommodating various components therein. The housing 11a may form an exterior of the washing machine 10a. The housing 11a may have a box shape with one part open.

The housing 11a may include a housing opening 12a formed to be accessible to the inside of the drum 30a. The housing opening 12a may open substantially upward.

The washing machine 10a may include a door 13a for opening and closing the housing opening 12a provided in the housing 11a. The door 13a may be rotatably mounted to the housing 11a by a hinge. At least a portion of the door 13a may be transparent or translucent so that an inside of the housing 11a can be seen.

The washing machine 10a may include a tub 20a provided inside the housing 11a to store water. The tub 20a may be disposed inside the housing 11a. The tub 20a may include a tub opening 22a provided to correspond to the housing opening 12a. The tub opening 22a may open substantially upward. The tub 20a may be supported inside the housing 11a. The tub 20a may have a substantially cylindrical shape with one side open.

The tub 20a may be elastically supported from the housing 11a by the damper 80a. The damper 80a may connect the housing 11a and the tub 20a. When the vibration generated by the rotation of the drum 30a is transmitted to the tub 20a and/or the housing 11a, the damper 80a may be provided to attenuate vibration by absorbing vibration energy between the tub 20a and the housing 11a.

The washing machine 10a may include a drum 30a provided to accommodate laundry. The drum 30a may be rotatably provided inside the tub 20a. The drum 30a may rotate within the tub 20a to perform washing, rinsing, and/or dehydration. The drum 30a may include a through hole 34a connecting the inner space of the drum 30a and the inner space of the tub 20a. The drum 30a may have a substantially cylindrical shape with one side open.

A balancing unit 36a may be installed on top of the drum 30a to solve load imbalance caused by laundry. The balancing unit 36a includes a housing having an annular channel and a ball or a fluid mass body movably provided inside the channel and can solve the load imbalance of the drum 30a while the ball or the fluid moves according to the rotation of the drum 30a.

The pulsator 37a is rotatably provided at the bottom of the drum 30a to generate a washing water flow. Laundry may be washed by the wash water flow generated by the pulsator 37a.

The drum 30a may include a drum opening 32a provided to correspond to the housing opening 12a and the tub opening 22a. Laundry may be put into the drum 30a or taken out of the drum 30a through the housing opening 12a, the tub opening 22a, and the drum opening 32a.

The washing machine 10a may include a washing machine driver 40a configured to rotate the drum 30a and the pulsator 37a. The washing machine driver 40a may include a driving motor 41a and a shaft system for transmitting the driving force generated by the driving motor 41a to the drum 30a and the pulsator 37a.

The driving motor 41a may include a fixed stator 48a and a rotor 49a that rotates by electromagnetically interacting with the stator 48a.

The shaft system may include a dehydration shaft 47a arranged to transmit the driving force of the driving motor 41a to the drum 30a, a washing shaft 46a provided to transmit the driving force of the driving motor 41a to the pulsator 37a, and a clutch device 45a that connects or disconnects the driving motor 41a and the dehydration shaft 47a.

The dehydration shaft 47a is formed to have a hollow, and the washing shaft 46a may be provided in the hollow of the dehydration shaft 47a. The washing shaft 46a remains connected to the rotor 49a of the driving motor 41a and the dehydration shaft 47a may be connected to or disconnected from the rotor 49a of the driving motor 41a by the clutch device 45a.

When the clutch device 45a disconnects the dehydration shaft 47a and the driving motor 41a, power is transmitted to the washing shaft 46a so that only the pulsator 37a rotates, and when the clutch device 45a connects the dehydration shaft 47a and the driving motor 41a, power is transmitted to both the dehydration shaft 47a and the washing shaft 46a so that the drum 30a and the pulsator 37a can rotate simultaneously.

When only the pulsator 37a rotates, washing water flow is generated by the rotation of the pulsator 37a, and laundry is rotated by the washing water flow and rubbed against the drum 30a, so that laundry can be washed. When the pulsator 37a and the drum 30a rotate at the same time, the laundry inside the drum 30a is rotated and the laundry is dehydrated by the centrifugal force, so that the laundry can be dehydrated.

The washing machine 10a may include a water supply device 50a. The water supply device 50a may supply water to the tub 20a. The water supply device 50a may be located above the tub 20a. The water supply device 50a may include a water supply pipe and a water supply valve provided in the water supply pipe. The water supply pipe may be connected to an external water supply source. The water supply pipe may extend from an external water supply source to the detergent supply device 60a and/or the tub 20a. Water may be supplied to the tub 20a via the detergent supply device 60a. Water may be supplied to the tub 20a without passing through the detergent supply device 60a.

The water supply valve may open or close the water supply pipe in response to an electrical signal from the controller 90a. The water supply valve may allow or block the supply of water from an external water supply source to the tub 20a. The water supply valve may include, for example, a solenoid valve that opens and closes in response to an electrical signal.

The washing machine 10a may include a detergent supply device 60a configured to supply detergent to the tub 20a. The detergent supply device 60a may be configured to supply detergent into the tub 20a during the water supply process. Water supplied through the water supply pipe can be mixed with detergent via the detergent supply device 60a. Water mixed with detergent may be supplied into the tub 20a. The detergent may include not only laundry detergent but also dryer rinse, deodorant, disinfectant or fragrance.

The washing machine 10a may include a drain device 70a. The drain device 70a may be configured to discharge water contained in the tub 20a to the outside. A drain port 21a may be formed at a lower portion of the tub 20a to drain water stored in the tub 20a to the outside of the tub 20a. A drain hose 74a may be connected to the drain hole 21a, and a drain valve 72a for opening and closing the drain hose 74a may be provided in the drain hose 74a.

The washing machine 10a may provide a user interface device 15a for interaction between the user and the washing machine 10a.

The washing machine 10a may include at least one user interface device 15a. The user interface device 15a may include at least one input interface 16a and at least one output interface 17a.

At least one input interface 16a may convert sensory information received from the user into an electrical signal.

At least one input interface 16a may include a power button, an operation button, a course selection dial (or a course selection button), and a washing/rinsing/dehydrating setting button. At least one input interface 16a may include, for example, a tact switch, a push switch, a slide switch, a toggle switch, a micro switch, a touch switch, a touch pad, a touch screen, a jog dial, and/or microphone, etc.

At least one output interface 17b may transmit various data related to the operation of the washing machine 10a to the user by generating sensory information.

For example, at least one output interface 17b may transmit information related to a washing course, an operating time of the washing machine 10a, and washing setting/rinsing setting/spinning setting to the user. Information on the operation of the washing machine 10a may be output through a screen, indicator, or voice. At least one output interface 17b may include, for example, a Liquid Crystal Display (LCD) panel, a Light Emitting Diode (LED) panel, a speaker, etc.

The clothes treating apparatus 1a may include the same filter apparatus 100 as the filter apparatus 100 shown in FIGS. 1 and 2. For example, the filter apparatus 100 according to an embodiment may be connected to a front-loading washing machine or a top-loading washing machine. The filter apparatus 100 provided to be connectable to the drain device 70a of the washing machine 10a. The filter apparatus 100 may be disposed outside the washing machine 10a. The filter apparatus 100 may be provided to filter foreign substances from water discharged from the washing machine 10a. The filter apparatus 100 may be provided to filter foreign substances having a size smaller than that of foreign substances filterable by the washing machine 10a. For example, the filter apparatus 100 may be provided to filter foreign substances having a size smaller than that of foreign substances filterable by the drain device 70a of the washing machine 10a.

The same control configuration as that of the washing machine 10 shown in FIG. 3 may be applied to the washing machine 10a of the clothes treating apparatus 1a shown in FIGS. 4 and 5.

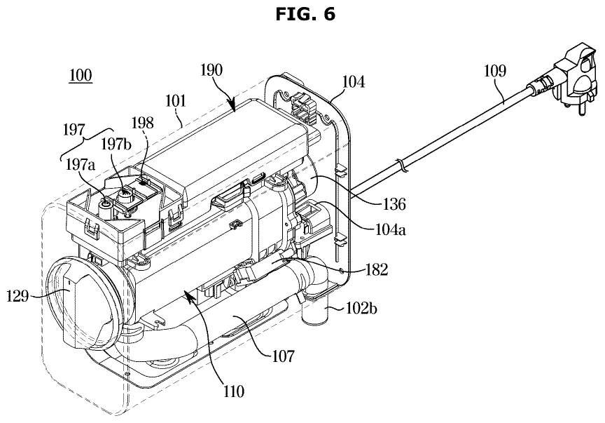

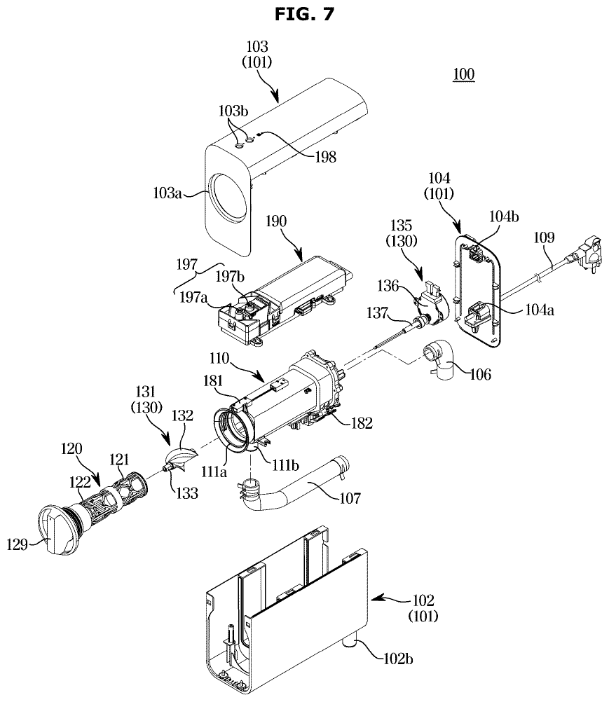

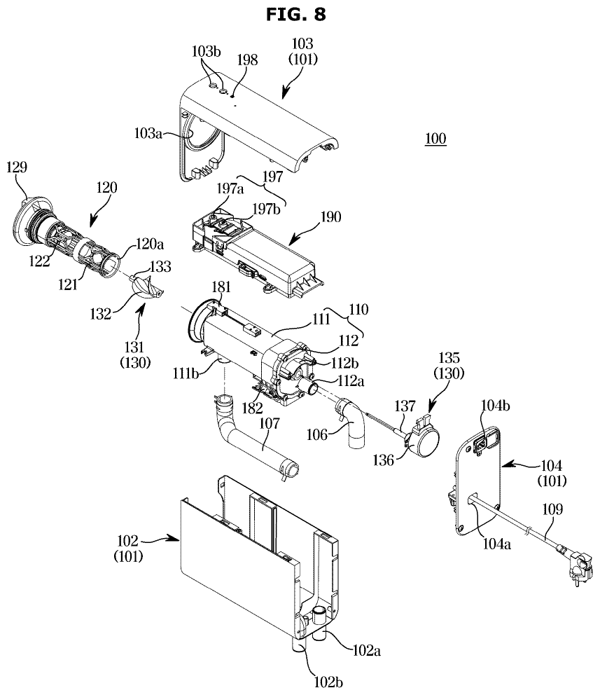

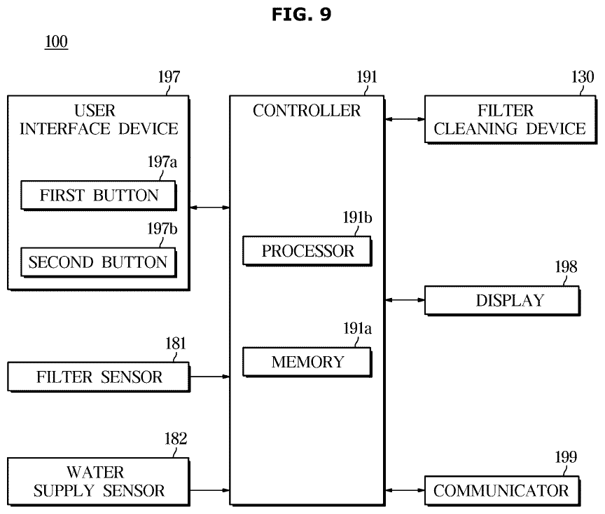

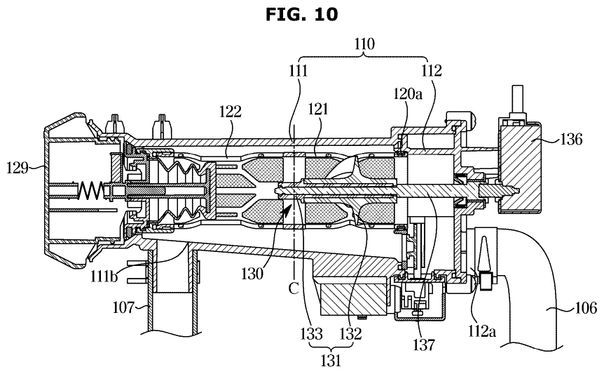

FIG. 6 shows an inside of a filter apparatus shown in FIG. 1 and FIG. 4. FIG. 7 is an exploded view of the filter apparatus shown in FIG. 6. FIG. 8 shows the filter apparatus shown in FIG. 7 in a different direction from FIG. 7. FIG. 9 is a control block diagram of the filter apparatus according to an embodiment. FIG. 10 shows a cross section of some components of the filter apparatus shown in FIG. 6.

Referring to FIGS. 6 to 8, the filter apparatus 100 according to an embodiment may include a filter housing 101 accommodating various components. The filter housing 101 may include a housing body 102, a housing cover 103, and a housing bracket 104. For example, the housing body 102, the housing cover 103, and the housing bracket 104 may be provided as separate components. For example, the housing body 102 may be integrally formed with the housing cover 103. For example, the housing body 102 may be integrally formed with the housing bracket 104. For example, the housing cover 103 may be integrally formed with the housing bracket 104. For example, the housing body 102 may be integrally formed with the housing cover 103 and the housing bracket 104.

The housing body 102 may form a space for accommodating various components. The housing body 102 may have a substantially U shape in cross section perpendicular to a direction in which the filter 120 accommodated therein extends. The housing body 102 may have a box shape with open front, rear and top surfaces. The housing body 102 may be detachably coupled to the housing cover 103 and/or the housing bracket 104.

The housing body 102 may include a housing inlet 102a for receiving water into the interior of the filter apparatus 100, and a housing outlet 102b for discharging water from the interior of the filter apparatus 100 to the exterior of the filter apparatus 100. The housing inlet 102a and/or the housing outlet 102b may be located at a lower portion of the housing body 102.

The housing inlet 102a may be connected with a drain hose 74, 74a of the washing machine 10 and 10a. The housing outlet 102b may be connected with a drain line 105.

The housing cover 103 may be provided to cover the open front and upper surfaces of the housing body 102. The housing cover 103 may be detachably coupled to the housing body 102 and/or the housing bracket 104. The housing cover 103 may include a cover opening 103a formed to allow the filter 120 to pass therethrough. The housing cover 103 may include an installation portion 103b where a user interface device 197 is installed. At least a portion of the user interface device 197 may be exposed to the outside of the filter apparatus 100 through the installation portion 103b.

The housing bracket 104 may be provided to cover the open rear surface of the housing body 102. The housing bracket 104 may be detachably coupled to the housing body 102 and/or the housing cover 103. The housing bracket 104 may include a cable opening 104a formed to allow the power cable 109 to pass therethrough. The housing bracket 104 may include a connector mounting portion 104b formed to connect a connector 108 for communication with an external device including the washing machine 10 and the like.

The filter apparatus 100 may include a filter case 110 located inside the filter housing 101. The filter case 110 may form a flow path through which water flowing into the filter apparatus 100 passes. The filter case 110 may be provided to accommodate the filter 120. The filter case 110 may include a case body 111 and a case cover 112.

The case body 111 may extend along the direction in which the filter 120 accommodated therein extends. The case body 111 may include a case opening 111a formed to allow the filter 120 to pass therethrough. The case opening 111a may be provided to correspond to the cover opening 103a. The case opening 111a is located closer to the case outlet 111b than the case inlet 112a, and may be provided so that the filter 120 can pass therethrough.

The case body 111 may include a case outlet 111b for discharging water flowing into the filter case 110 from the filter case 110. The case outlet 111b may be located at a lower portion of the case body 111. The case outlet 111b may be located adjacent to the case opening 111a. The case outlet 111b may be located close to the other end opposite to one end where the filter opening 120a of the filter 120 is located. The case outlet 111b may be located closer to a second filter portion 122 than to a first filter portion 121 of the filter 120.

The case outlet 111b may be connected to the housing outlet 102b. The filter apparatus 100 may include a discharge guide 107 for connecting the case outlet 111b and the housing outlet 102b.

The case cover 112 may be detachably coupled to the other end opposite to one end of the case body 111 where the case opening 111a is located. For example, the case cover 112 may be integrally formed with the case body 111.

The case cover 112 may include a case inlet 112a through which water flows into the filter case 110. The case inlet 112a may be connected to the housing inlet 102a. The filter apparatus 100 may include an inflow guide 106 for connecting the case inlet 112a and the housing inlet 102a.

The case cover 112 may include a motor mounting portion 112b for mounting a filter cleaning device 130 thereon. The motor mounting portion 112b may be positioned above the case inlet 112a. The cleaning motor 136 of the filter cleaning device 130 may be mounted on the motor mounting portion 112b.

The filter apparatus 100 may include the filter 120 detachably coupled to the filter case 110. The filter 120 may be provided to filter fine-sized foreign substances. The filter 120 may be provided to filter microplastics having a size of about 5 mm or less. The filter 120 may include a mesh filter. The filter 120 may extend approximately between the case inlet 112a and the case outlet 111b.

When the filter 120 is mounted on the filter case 110, the filter 120 may include a filter opening 120a opened toward the case inlet 112a. Water flowing into the filter case 110 through the case inlet 112a may move into the filter 120 through the filter opening 120a.

The filter 120 may include the first filter portion 121 and the second filter portion 122. The first filter portion 121 may be located closer to the case inlet 112a than the second filter portion 122. In the water flowing into the filter case 110, foreign substances may be filtered through the first filter portion 121 or may not be filtered in the first filter portion 121, and after passing through the first filter portion 121, foreign substances may be filtered in the second filter portion 122. The first filter portion 121 and the second filter portion 122 may be sequentially disposed along a direction in which the filter 120 extends. Foreign substances transferred from the first filter portion 121 may be collected in the second filter portion 122 by the filter cleaning device 130.

The filter apparatus 100 may include a handle 129 at least partially exposed to the outside of the filter housing 101 when the filter 120 is mounted on the filter case 110. For example, the handle 129 may be detachably coupled to the filter 120. As the handle 129 is detachably coupled to the filter 120, the filter 120 can be easily maintained and/or repaired. The handle 129 may rotate and be coupled to the cover opening 103a and/or the case opening 111a.

The filter apparatus 100 may include the filter cleaning device 130 for cleaning the filter 120. The filter cleaning device 130 may be mounted on the filter case 110. The filter cleaning device 130 may include a cleaning member 131 for cleaning the surface of the filter 120 through which foreign substances are filtered, and a cleaning driving device 135 for driving the cleaning member 131.

The cleaning member 131 may be located inside the filter 120. The cleaning member 131 may be provided to correspond to the first filter portion 121 of the filter 120. The cleaning member 131 may have a spirally extending blade 132. The blade 132 may extend in a radial direction from the rotation axis of the cleaning member 131. The cleaning member 131 may be provided to contact the surface of the filter 120 through which foreign substances are filtered. The cleaning member 131 may be provided to contact the inner surface of the filter 120. For example, the cleaning member 131 may include a plurality of brushes.

While the cleaning member 131 is driven by the cleaning driving device 135, the cleaning member 131 may be arranged to transfer foreign substances being filtered from a portion of the filter 120 closer to the case inlet 112a to a portion of the filter 120 closer to the case outlet 111b of the filter 120. The cleaning member 131 may be provided to transfer foreign substances filtered through the first filter portion 121 to the second filter portion 122. For example, the cleaning member 131 may be rotatably provided inside the filter 120. The cleaning member 131 may include a flexible material. The cleaning member 131 rotates in contact with the filter 120 and can clean foreign substances filtered by the filter 120. While the cleaning member 131 is driven in contact with the filter 120, the cleaning member 131 can scrape and remove foreign substances attached to the surface of the filter 120 through which foreign substances are filtered. For example, the cleaning member 131 may be slidably provided inside the filter 120.

As the cleaning member 131 is provided to transfer foreign substances filtered by the first filter portion 121 to the second filter portion 122 and the water flowing into the filter case 110 flows from the first filter portion 121 to the second filter portion 122, foreign substances filtered through the first filter portion 121 may be efficiently collected in the second filter portion 122. Considering the flow of water passing through the filter 120, the cleaning member 131 may be disposed behind a reference line C shown in FIG. 10 and the case outlet 111b may be disposed in front of the reference line C shown in FIG. 10.

The cleaning driving device 135 may include a cleaning motor 136 and a motor shaft 137. The cleaning motor 136 may be configured to generate power for driving the cleaning member 131. The motor shaft 137 may be connected to the cleaning member 131. The cleaning motor 136 may be mounted on the filter case 110. The cleaning motor 136 may be located closer to the case inlet 112a than to the case outlet 111b.

The filter apparatus 100 may include a circuitry 190 located inside the filter housing 101. The circuitry 190 may be located at the upper end of the inside of the filter housing 101. The circuitry 190 may be located on one side of the filter case 110. For example, the circuitry 190 may be located above the filter case 110. For example, the circuitry 190 may be disposed above the filter 120.

The circuitry 190 may include a controller 191 for controlling the filter apparatus 100 and a communication part 199 for communicating with the washing machines 10 and 10a.

The filter apparatus 100 may include the user interface device 197 positioned above the circuitry 190. At least a portion of the user interface device 197 may be exposed to the outside of the filter apparatus 100 through the installation portion 103b of the filter housing 101. The user interface device 197 may be located on the upper surface of the filter apparatus 100. The user interface device 197 may include a first button 197a and a second button 197b. The first button 197a may include one of a power button and a WiFi connection button. The second button 197b may include a power button and a Wi-Fi connection button different from the first button 197a.

The filter apparatus 100 may include a display 198 displaying visualized information related to the filter apparatus 100. The display 198 may be located on the upper surface of the filter apparatus 100. For example, the display 198 may be provided as one component of the user interface device 197.

The filter apparatus 100 may include a filter sensor 181 that acquires information about the state of the filter 120. The filter sensor 181 may be mounted on the filter case 110. The filter sensor 181 may be located outside the filter case 110. The filter sensor 181 may be positioned to correspond to the second filter portion 122 of the filter 120 mounted on the filter case 110. For example, the filter sensor 181 may include a magnetic sensor. For example, the filter sensor 181 may include an optical sensor.

The filter apparatus 100 may include a water supply sensor 182 for detecting that water is supplied to the filter apparatus 100. The water supply sensor 182 may be mounted on the lower part of the filter case 110. The water supply sensor 182 may be located close to the case inlet 112a of the filter case 110.

FIG. 9 is a control block diagram of the filter apparatus according to an embodiment.

The filter apparatus 100 according to an embodiment includes a user interface device 197 for interacting with a user, a filter sensor 181, a water supply sensor 182, a filter cleaning device 130, a display 198, a communication part 199, and a controller 191 for controlling various configurations of the filter apparatus 100.

The controller 191 may include at least one memory 191a and at least one processor 191b to perform the above-described operation and the operation to be described later.

In an embodiment, the controller 191 may include at least one memory 191a that stores data in the form of an algorithm and/or program for controlling the operation of components in the filter apparatus 100 and at least one processor 191b that performs the above-described operation and the below-described operation using data stored in the at least one memory 191a. The memory 191a and the processor 191b may be implemented as separate chips. The processor 191b may include one or more processor chips or may include one or more processing cores. The memory 191a may include one or more memory chips or one or more memory blocks. Also, the memory 191a and the processor 191b may be implemented as a single chip.

The controller 191 may process a user input received through the user interface device 197 and control various components of the filter apparatus 100 (e.g. filter cleaning device 130, display 198) based on the processed user input.

The user interface device 197 may include a first button 197a and a second button 197b, and may be operable based on a control signal from the controller 191.

The filter sensor 181 may be mounted on the filter case 110. The filter sensor 181 may detect the amount of foreign substances collected in the filter 120.

For example, the filter sensor 181 may include an optical sensor (e.g. an infrared sensor) that detects the amount of foreign substances collected in the filter 120. However, the type of filter sensor 181 is not limited thereto, and any configuration capable of detecting the amount of foreign substances collected in the filter 120 may be adopted as the filter sensor 181.

The water supply sensor 182 may be mounted on the filter case 110. The water supply sensor 182 may detect the inflow of water into the filter case 110.

For example, the water supply sensor 182 may include a capacitive sensor that detects the inflow of water into the filter case 110. However, the type of water supply sensor 182 is not limited thereto, and any configuration capable of detecting the inflow of water into the filter case 110 may be adopted as the water supply sensor 182.

The controller 191 may process sensor data received through the filter sensor 181 and/or the water supply sensor 182 and control various components of the filter apparatus 100 (e.g. filter cleaning device 130) based on the processed sensor data.

The filter cleaning device 130 may include a cleaning member 131 slidably and rotatably inserted into the inner surface of the filter 120 and a cleaning motor 136 for rotating the cleaning member 131.

The controller 191 may control the filter cleaning device 130.

In an embodiment, the controller 191 may control a driving circuit that applies driving current to the cleaning motor 136. The driving circuit may supply driving current to the cleaning motor 136 in response to a driving signal from the controller 191. The driving circuit may include a rectifying circuit for rectifying AC power of an external power source, a DC link circuit that removes ripple of the rectified power and outputs DC power, an inverter circuit that converts DC power into sine wave type driving power and outputs the driving current to the cleaning motor 136, a current sensor that measures a driving current supplied to the cleaning motor 136, and a gate driver that turns on/off the switching element included in the inverter circuit based on a driving signal from the controller 191.

The driving circuit connected to the cleaning motor 136 may include components for driving the DC motor.

The display 198 may display visualized information related to the filter apparatus 100. For example, the display 198 may be provided in a separate configuration from the user interface device 197. For example, the display 198 may be provided as one component of the user interface device 197.

The communication part 199 may transmit data to an external device or receive data from the external device based on a control signal of the controller 191. For example, the communication part 199 may transmit/receive various types of data by communicating with a server and/or a user terminal device and/or home appliances including the washing machines 10 and 10a.

For this, the communication part 199 may establish a direct (wired) communication channel or a wireless communication channel with an external electronic device (for example, a server, a user terminal, and/or a home appliance), and support communication through the established communication channel. According to an embodiment of the disclosure, the communication part 199 may include a wireless communicator (for example, a cellular communicator, a short-range wireless communicator, or a global navigation satellite system (GNSS) communicator), or a wired communicator (for example, a local area network (LAN) communicator or a power line communicator). A corresponding communicator among the communicators may communicate with an external electronic device through a first network (for example, a short-range communication network, such as Bluetooth, wireless fidelity (WiFi) direct, or infrared data association (IrDA)) or a second network (for example, a telecommunication network, such as a legacy cellular network, a 5G network, a next-generation communication network, internet, or a computer network (for example, a local area network (LAN) or a wide area network (WAN)). Such various kinds of communicators may be integrated into a component (for example, a single chip) or implemented as a plurality of independent components (for example, a plurality of chips).

According to various embodiments, the communication part 199 may establish communication with a user terminal device through a server.

According to various embodiments of the disclosure, the communication part 199 may include a WiFi module, and may perform communication with an external server and/or a user terminal based on communication establishment with an Access Point (AP) in home.

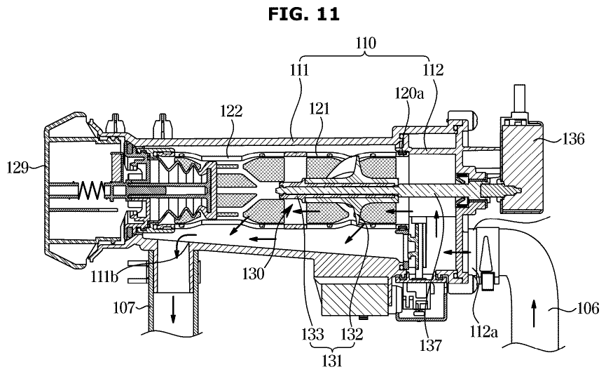

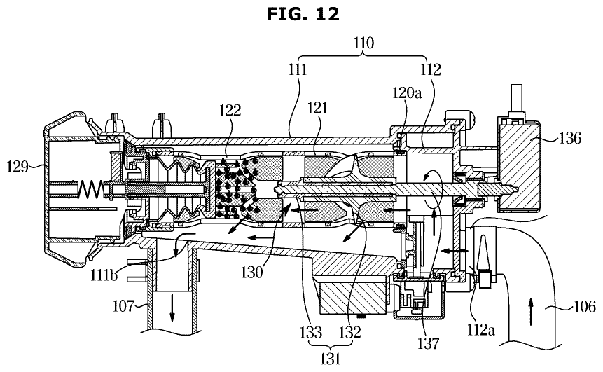

FIG. 11 shows a flow of water flowing into a filter case shown in FIG. 10 and then being discharged after passing through the filter. FIG. 12 shows a state in which foreign substances inside the filter are collected by the filter cleaning device shown in FIG. 10.

Referring to FIG. 11, water flowing into the filter apparatus 100 through the housing inlet 102a may be guided to the filter case 110 by the inflow guide 106. Water flowing into the filter case 110 through the case inlet 112a may flow into the filter 120 through the filter opening 120a. Water introduced into the filter case 110 may flow into the filter 120. Water flowing into the filter 120 passes through the filter 120 and foreign substances can be filtered out. Water passing through the filter 120 may be discharged to the outside of the filter case 110 through the case outlet 111b. Water discharged through the case outlet 111b may be discharged from the filter apparatus 100 by sequentially passing through the discharge guide 107 and the housing outlet 102b. Water discharged from the filter apparatus 100 may be guided through a drain line 105.

Referring to FIG. 12, while water introduced into the filter case 110 passes through the filter 120 and foreign substances are filtered, foreign substances may accumulate on an inner surface (a filtering surface) of the filter 120. The filter cleaning device 130 may transfer foreign substances accumulated on an inner surface of the filter 120 to one end of the filter 120. The filter cleaning device 130 may remove foreign substances filtered on the inner surface of the filter 120 from the inner surface. The filter cleaning device 130 may clean the inner surface of the filter 120 on which the foreign substances are filtered. The filter cleaning device 130 may clean the filter 120 as the blade 132 rotates relative to the filter 120 while being in contact with the inner surface of the filter 120.

The blade 132 of the filter cleaning device 130 may be subject to damage and/or wear. When the blade 132 of the filter cleaning device 130 is damaged and/or worn, the cleaning efficiency of the filter 120 may be reduced.

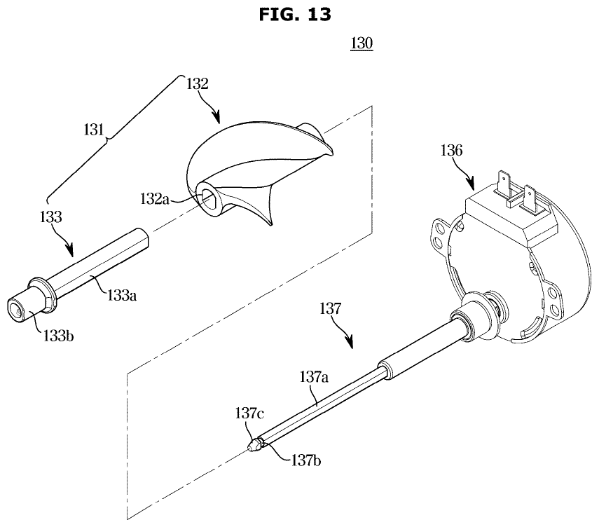

FIG. 13 shows an exploded view of the cleaning member of the filter cleaning device shown in FIGS. 7 and 8.

Referring to FIG. 13, a cleaning member 131 of the filter cleaning device 130 according to an embodiment may include a blade 132 configured to contact an inner surface of the filter 120. The blade 132 may extend helically from a rotational axis of the cleaning member 131. The blade 132 may extend radially from the rotational axis of the cleaning member 131. The blade 132 may be detachably provided from the cleaning driving device 135.

The blade 132 may include a bracket coupling portion 132a into which a blade bracket 133 is insertable. As at least a portion of the blade bracket 133 is inserted into the bracket coupling portion 132a, the blade 132 may be coupled to the blade bracket 133. The bracket coupling portion 132a may be formed to have a shape and/or size corresponding to the blade bracket 133. The bracket coupling portion 132a may be configured to receive rotational force from the blade bracket 133 when the blade bracket 133 is inserted. The bracket coupling portion 132a may be configured to allow the blade 132 to rotate together with the blade bracket 133 while the blade bracket 133 rotates.

The cleaning driving device 135 of the filter cleaning device 130 may include a blade bracket 133 that connects the blade 132 to a motor shaft 137. At least a portion of the blade bracket 133 may be insertable into the blade 132. The blade bracket 133 may be detachably coupled to the blade 132.

The blade bracket 133 may include a material having elasticity. The blade bracket 133 may include a material having greater rigidity than the blade 132. The blade bracket 133 may include a material more flexible than the motor shaft 137.

The blade bracket 133 may include a bracket body 133a that is inserted into the blade 132. The bracket body 133a may be insertable into the bracket coupling portion 132a. The bracket body 133a may be formed to have a shape and/or size corresponding to the bracket coupling portion 132a. The bracket coupling portion 132a may be configured to transmit rotational force from the motor shaft 137 to the blade 132.

The cleaning driving device 135 may include a cleaning motor 136 and a motor shaft 137 coupled to the cleaning motor 136. As the cleaning motor 136 operates, the motor shaft 137 may rotate. As the motor shaft 137 rotates, the blade bracket 133 may rotate. As the blade bracket 133 rotates, the blade 132 may rotate. At least a portion of the motor shaft 137 may be insertable into the blade bracket 133. The motor shaft 137 may be detachably coupled to the blade bracket 133.

The motor shaft 137 may include a shaft coupling portion 137a that is coupled to the blade bracket 133. The shaft coupling portion 137a may be insertable into the blade bracket 133. The shaft coupling portion 137a may be configured to transmit rotational force of the motor shaft 137 to the blade bracket 133.

Accordingly, the filter apparatus 100 according to an embodiment may allow the blade 132 of the cleaning member 131 of the filter cleaning device 130 to be easily replaced, therefore, maintenance and/or repair of the blade 132 may be facilitated.

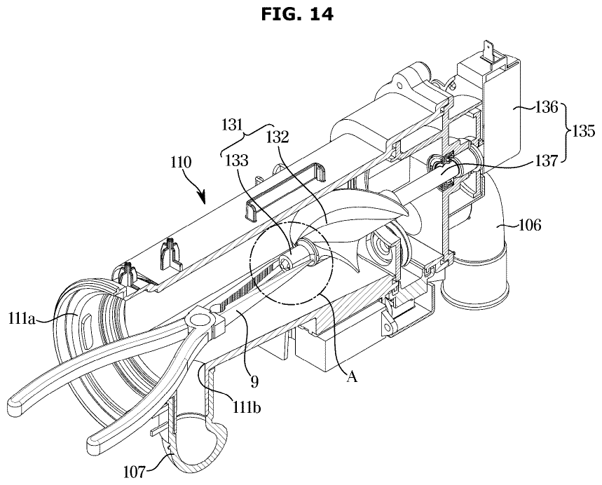

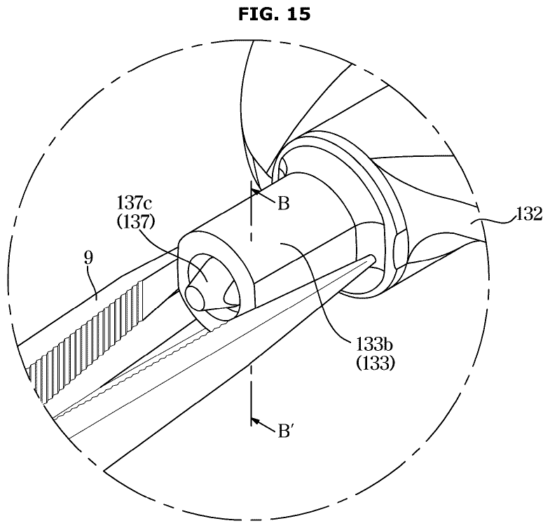

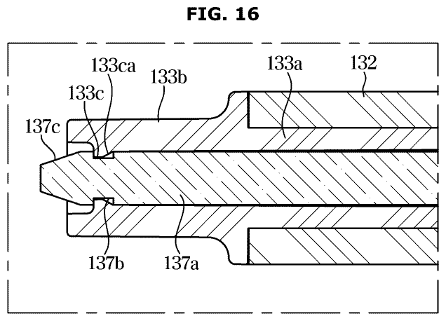

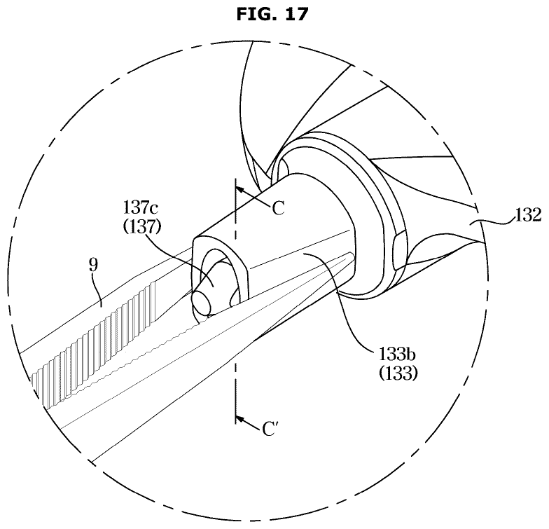

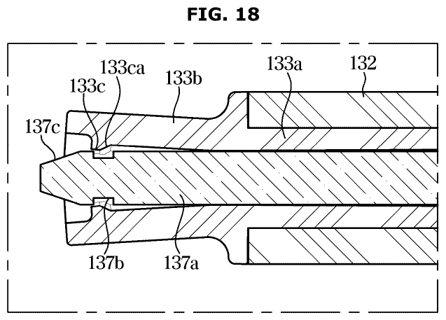

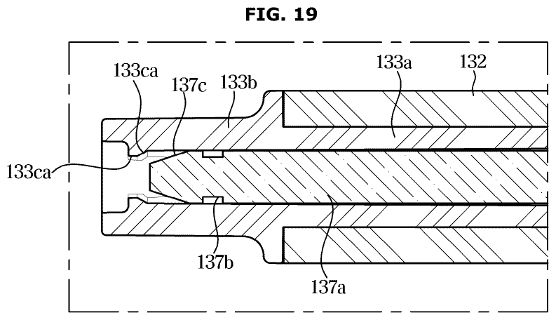

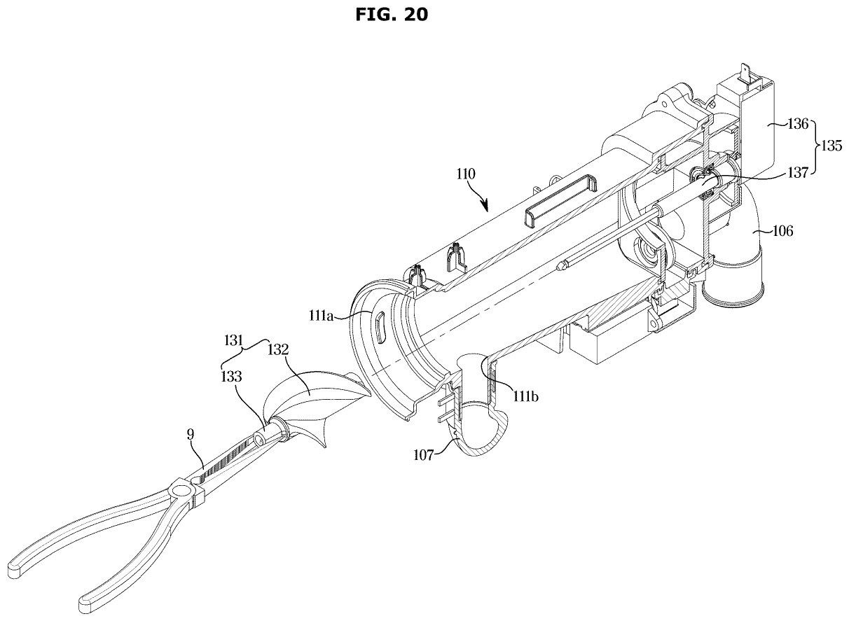

FIG. 14 shows a state in which the filter is separated from the filter case to detach the blade from the filter cleaning device shown in FIG. 10. FIG. 15 shows an enlarged view of a portion A shown in FIG. 14. FIG. 16 shows a cross-sectional view taken along line B-B′ of FIG. 15. FIG. 17 shows a state in which the deformable portion of the cleaning member shown in FIG. 15 is deformed. FIG. 18 shows a cross-sectional view taken along line C-C′ of FIG. 17. FIG. 19 shows separation of the blade bracket from the motor shaft shown in FIG. 18. FIG. 20 shows removal of the blade from the filter case shown in FIG. 14.

Referring to FIGS. 14 to 20, a configuration for replacing the blade 132 of the filter cleaning device 130 will be described.

Referring to FIGS. 14 and 15, the filter apparatus 100 according to an embodiment may allow the filter 120 to be removed from the filter case 110 in order to maintain and/or repair the blade 132 of the filter cleaning device 130. As the filter 120 is removed from the filter case 110, the filter apparatus 100 may be in a state in which the cleaning member 131 of the filter cleaning device 130 is accessible through a case opening 111a.

The blade bracket 133 of the filter cleaning device 130 may include a deformable portion 133b. The deformable portion 133b may be configured to be deformable when a force greater than a predetermined level is applied. For example, the deformable portion 133b may be configured to be deformable when pressed by a tool 9.

The deformable portion 133b may be located at an end of the cleaning member 131 opposite to the end coupled to the cleaning driving device 135 when the cleaning member 131 is mounted to the cleaning driving device 135. The deformable portion 133b may be configured to face the case opening 111a when the cleaning member 131 of the filter cleaning device 130 is coupled to the cleaning driving device 135 and positioned inside the filter case 110. The deformable portion 133b may be located at a position where it can be pressed by inserting a tool 9 through the case opening 111a.

Referring to FIGS. 15 and 16, the blade bracket 133 may include a coupling guide 133c provided at the deformable portion 133b. The motor shaft 137 may include a guide coupling portion 137b that is couplable with the coupling guide 133c of the blade bracket 133. The coupling guide 133c may have a protrusion shape, and the guide coupling portion 137b may have a groove shape corresponding thereto. The shapes of the coupling guide 133c and the guide coupling portion 137b are not limited thereto.

When the blade bracket 133 is coupled to the motor shaft 137, the coupling guide 133c may be coupled to the guide coupling portion 137b. When the coupling guide 133c is coupled to the guide coupling portion 137b, separation of the blade bracket 133 from the motor shaft 137 may be restricted.

Referring to FIGS. 17 and 18, as the deformable portion 133b is pressed by the tool 9, the deformable portion 133b may be deformed so that the position of the coupling guide 133c is changed. When a force greater than a predetermined level is applied to the deformable portion 133b in a predetermined direction, the coupling guide 133c may move to be disengaged from the guide coupling portion 137b as the deformable portion 133b is deformed.

For example, the coupling guide 133c may include a plurality of coupling guides 133c arranged to face each other. As an external force is applied such that a portion of the deformable portion 133b, different from the portion where the plurality of coupling guides 133c are located, moves closer together, the deformable portion 133b may be deformed such that the portions where the plurality of coupling guides 133c are located move away from each other. As the portions of the deformable portion 133b where the plurality of coupling guides 133c are located move away from each other, the plurality of coupling guides 133c may move in a direction in which they are disengaged from the guide coupling portion 137b.

Referring to FIGS. 19 and 20, as shown in FIGS. 17 and 18, when a force is applied to the blade bracket 133 in a direction toward the outside of the filter case 110 in a state where the coupling guide 133c is disengaged from the guide coupling portion 137b, the blade bracket 133 may be separated from the motor shaft 137 and moved to the outside of the filter case 110. The blade 132 may be separated from the motor shaft 137 together with the blade bracket 133 while remaining coupled to the blade bracket 133.

The filter apparatus 100 according to an embodiment may be configured to allow access to the deformable portion 133b of the cleaning member 131 in a state where the filter 120 is removed from the filter case 110, so that the cleaning member 131 can be easily separated from the cleaning driving device 135. As the cleaning member 131 is easily separated from the cleaning driving device 135, the blade 132 of the cleaning member 131 can be easily maintained and/or repaired.

The cleaning member 131 may include a guide slope 133ca formed on the coupling guide 133c. The guide slope 133ca may guide the cleaning member 131 while the cleaning member 131 is being mounted to the cleaning driving device 135. The guide slope 133ca may be formed to be inclined with respect to a direction in which the cleaning member 131 is mounted to the cleaning driving device 135.

The motor shaft 137 may include a shaft slope 137c for guiding the cleaning member 131 while the cleaning member 131 is being mounted to the cleaning driving device 135. The shaft slope 137c may deform the deformable portion 133b so that the coupling guides 133c move away from each other while the cleaning member 131 is being mounted to the cleaning driving device 135. The shaft slope 137c may be formed to be inclined with respect to a direction in which the cleaning member 131 is mounted to the cleaning driving device 135. The shaft slope 137c may be formed to be inclined corresponding to the guide slope 133ca. The shaft slope 137c may be formed such that a cross-section perpendicular to a direction in which the cleaning member 131 is mounted to the cleaning driving device 135 increases toward the direction in which the cleaning member 131 is mounted to the cleaning driving device 135.

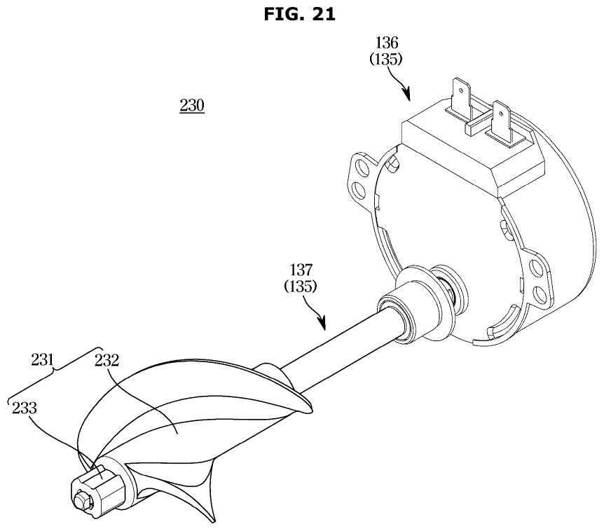

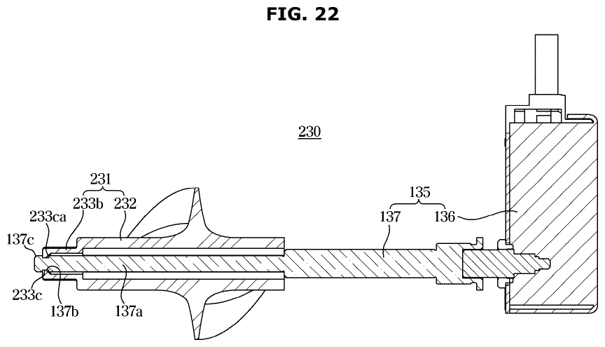

FIG. 21 shows a filter cleaning device according to an embodiment. FIG. 22 shows a cross-sectional view of the filter cleaning device shown in FIG. 21.

Referring to FIGS. 21 and 22, a filter cleaning device 230 according to an embodiment will be described. In the description of the filter cleaning device 230 shown in FIGS. 21 and 22, the same reference numerals are used for components that are the same as those of the filter cleaning device 130 shown in FIGS. 14 to 20, and detailed descriptions thereof will be omitted.

Referring to FIGS. 21 and 22, the filter cleaning device 230 may include a cleaning member 231 and a cleaning driving device 135.

The cleaning member 230 may include a blade 232 and a deformable portion 233b that is integrally formed with the blade 232. In the cleaning member 130 shown in FIGS. 14 to 20, a blade bracket 133, which includes a deformable portion 133b configured to separate the cleaning member 130 from the cleaning driving device 135, is provided separately from the blade 132, however, in the cleaning member 230 shown in FIGS. 21 and 22, the deformable portion 233b configured to separate the cleaning member 230 from the cleaning driving device 135 is integrally formed with the blade 232.

A coupling guide 233c that is couplable with a guide coupling portion 137b provided on the motor shaft 137 may be formed on the deformable portion 233b that is integrally formed with the blade 232. The coupling guide 233c may include a guide slope 233ca for guiding the cleaning member 230 while the cleaning member 230 is being mounted to the cleaning driving device 135.

The motor shaft 137 may include a shaft coupling portion 137a coupled to the blade 232, a guide coupling portion 137b couplable with the coupling guide 233c, and a shaft slope 137c for guiding the mounting of the cleaning member 230.

In the filter cleaning device 230 according to an embodiment, since the deformable portion 233b for detachably mounting the cleaning member 230 to the cleaning driving device 135 is integrally provided with the blade 232, the configuration can be simplified and costs can be reduced.

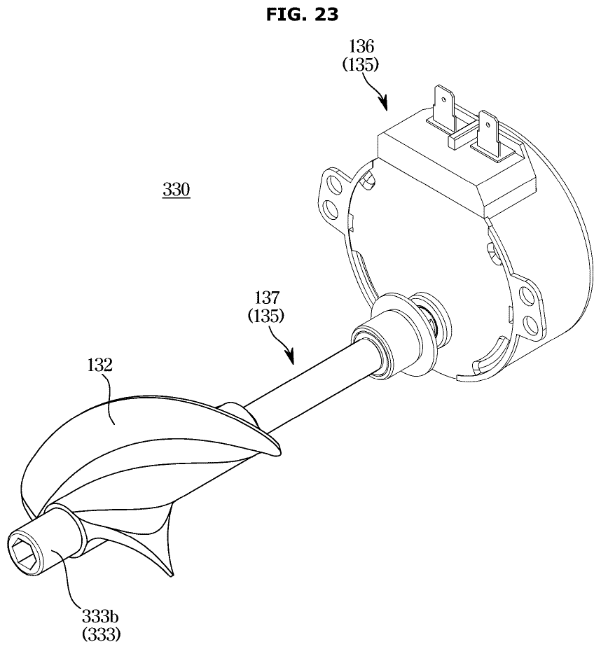

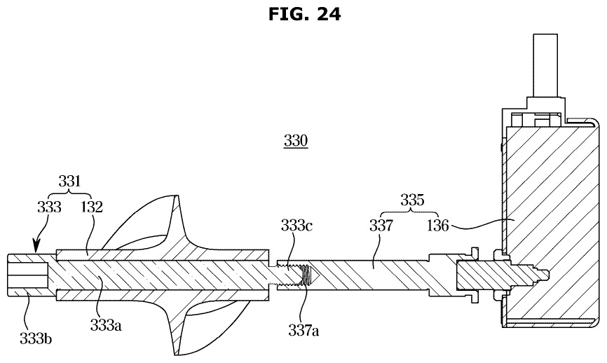

FIG. 23 shows a filter cleaning device according to an embodiment. FIG. 24 shows a cross-sectional view of the filter cleaning device shown in FIG. 23.

Referring to FIGS. 23 and 24, a filter cleaning device 330 according to an embodiment will be described. In the description of the filter cleaning device 330 shown in FIGS. 23 and 24, the same reference numerals are used for components that are the same as those of the filter cleaning device 130 shown in FIGS. 14 to 20, and detailed descriptions thereof will be omitted.

Referring to FIGS. 23 and 24, a filter cleaning device 330 according to an embodiment may include a cleaning member 331 and a cleaning driving device 335.

In the cleaning device 330 according to an embodiment, the blade bracket 333 of the cleaning member 331 and the motor shaft 337 of the cleaning driving device 335 may be configured to be screw-coupled. The blade bracket 333 may include a bracket coupling portion 333c on which threads are formed. The motor shaft 337 may include a shaft coupling portion 337a configured to correspond to the bracket coupling portion 333c.

The blade bracket 333 may include a bracket body 333a inserted into the blade 132 and an operation portion 333b located at an end opposite to an end where the bracket coupling portion 333c of the bracket body 333a is positioned. By operating the operation portion 333b, the cleaning member 331 may be separated from the cleaning driving device 335. For example, an operator may rotate the operation portion 333b using a hex wrench, and as the operation portion 333b is rotated, the blade bracket 333 may rotate and be separated from the motor shaft 337.

Accordingly, the filter cleaning device 330 according to an embodiment may allow the cleaning member 331 to be easily separated from the cleaning driving device 335.

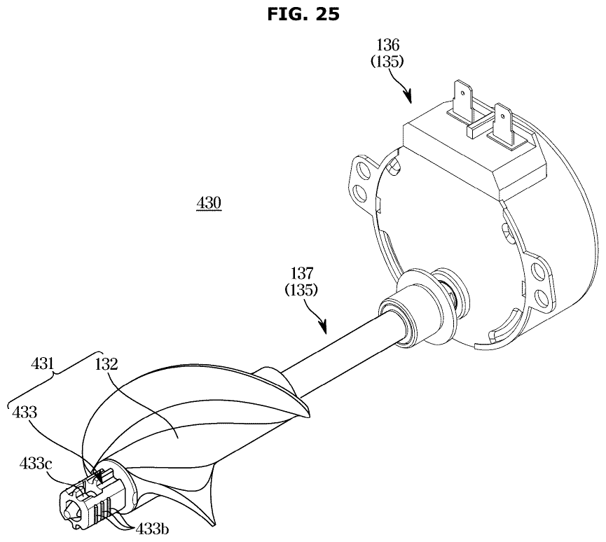

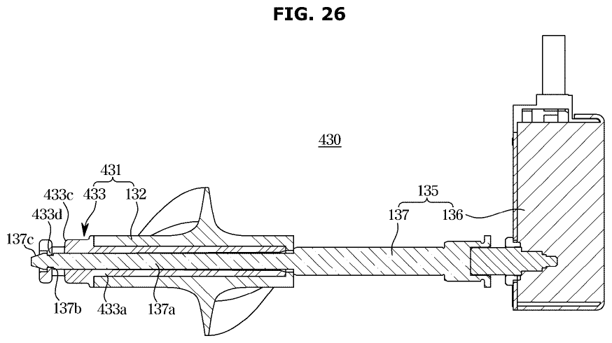

FIG. 25 shows a filter cleaning device according to an embodiment. FIG. 26 shows a cross-sectional view of the filter cleaning device shown in FIG. 25.

Referring to FIGS. 25 and 26, a filter cleaning device 430 according to an embodiment will be described. In the description of the filter cleaning device 430 shown in FIGS. 25 and 26, the same reference numerals are used for components that are the same as those of the filter cleaning device 130 shown in FIGS. 14 to 20, and detailed descriptions thereof will be omitted.

Referring to FIGS. 25 and 26, a filter cleaning device 430 according to an embodiment may include a cleaning member 431 and a cleaning driving device 135.

The cleaning member 431 may include a blade 132 and a blade bracket 433 to which the blade 132 is detachably coupled. The blade bracket 433 may be detachably coupled to the motor shaft 137 of the cleaning driving device 135.

The motor shaft 137 may include a shaft coupling portion 137a coupled to the blade 132, a guide coupling portion 137b couplable with a coupling guide 433d, and a shaft slope 137c for guiding the mounting of the cleaning member 431.

The blade bracket 433 may include a bracket body 433a inserted into the blade 132. The bracket body 433a may be detachably coupled to the blade 132. The bracket body 433a may be coupled to the blade 132 so as to be rotatable together.

The blade bracket 433 may include a pressing portion 433b and a deformable portion 433c that are exposed to the outside of the blade 132 when the blade bracket 433 is coupled to the blade 132.

The blade bracket 433 may include a pressing portion 433b that protrudes from a portion pressed by a tool 9. The pressing portion 433b may increase friction between the tool 9 and the blade bracket 433 when pressed by the tool 9. A plurality of pressing portions 433b may be provided.

The blade bracket 433 may include a deformable portion 433c located in a portion different from a portion pressed by the tool 9. The deformable portion 433c may be deformed away from the motor shaft 137 while a portion of the blade bracket 433 where the pressing portion 433b is located is pressed by the tool 9 and deformed toward the motor shaft 137. The deformable portion 433c may have a smaller thickness than the pressing portion 433b to facilitate deformation. The deformable portion 433c may include a portion having a hole shape.

The blade bracket 433 may include a coupling guide 433d that is detachably coupled to the guide coupling portion 137b.

Accordingly, the filter cleaning device 430 according to an embodiment may allow the cleaning member 431 to be easily separated from the cleaning driving device 135.

A filter apparatus 100 according to an embodiment, to be disposed outside a washing machine 10 and 10a, connectable to a drain device 70 and 70a of the washing machine, the filter apparatus 100 comprises a filter case 110, a filter 120 coupleable to and decoupleable from the filter case, and a filter cleaning device 130 configured to clean the filter. The filter cleaning device includes a cleaning driving device 135 mountable in the filter case, and a cleaning member 131 couplable to and decoupleable from the cleaning driving device, the cleaning member including a portion 133b configured to be deformable while the cleaning member is decoupled from the cleaning driving device. Accordingly, the filter apparatus 100 according to an embodiment may facilitate maintenance and/or repair of the cleaning member 131.

The cleaning member may include a blade bracket 133 including the portion and configured to be coupled to the cleaning driving device, and a blade 132 couplable to the blade bracket and including a material more flexible than the blade bracket. The filter apparatus 100 according to an embodiment may reduce loss of rotational force transmitted from the cleaning driving device, since the blade bracket is made of a material having greater rigidity than the blade.

The blade bracket may include a coupling guide 133c configured to change position as the portion deforms. The cleaning driving device may include a guide coupling portion 137b couplable to the coupling guide 133c.

The coupling guide may be deformable by the cleaning driving device while the cleaning member is being coupled to the cleaning driving device, and may be configured to be restored when the cleaning member is coupled to the cleaning driving device. The filter apparatus 100 according to an embodiment may allow the cleaning member to be easily mounted to the cleaning driving device.

The blade bracket may include a guide slope 133ca provided in the coupling guide, the guide slope being configured to guide deformation of the portion while the cleaning member is being coupled to the cleaning driving device. The filter apparatus 100 according to an embodiment may enable the cleaning member to be easily mounted to the cleaning driving device.

The blade bracket may include a reduced portion 433b positioned adjacent to the coupling guide. The filter apparatus 100 according to an embodiment may deform the deformable portion with a relatively small force.

The cleaning driving device may include a cleaning motor, and a motor shaft coupled to the blade bracket to transmit a driving force of the cleaning motor to the blade bracket, the motor shaft including a material having greater rigidity than the blade bracket. The filter apparatus 100 according to an embodiment may reduce loss of rotational force transmitted from the cleaning driving device to the cleaning member.

The portion may be located at an end of the cleaning member opposite to an end connected to the cleaning driving device. The filter apparatus 100 according to an embodiment may have improved accessibility to the deformable portion.

The cleaning driving device may include a shaft slope 137c configured to guide deformation of the portion while the cleaning member is being mounted. The filter apparatus 100 according to an embodiment may allow the cleaning member to be easily mounted to the cleaning driving device.

The portion may be configured to be accessible when the filter is separated from the filter case. The filter apparatus 100 according to an embodiment may have improved accessibility to the deformable portion.

The portion may include an elastic material configured to allow deformation and restoration.

The cleaning member may be configured to contact an inner circumferential surface of the filter.

The cleaning member may include a blade integrally formed with the portion. The filter apparatus 100 according to an embodiment may simplify the configuration.

The cleaning member may includes a blade bracket screwed to the cleaning driving device, and a blade coupled to the blade bracket and including a material more flexible than the blade bracket. The filter apparatus 100 according to an embodiment may reduce the loss of rotational force transmitted from the cleaning driving device to the cleaning member.

A clothes treating apparatus 1, 1a according to an embodiment comprises a washing machine 10, 10a including a washing machine housing 11, 11a, a tub 20, 20a to be provided inside the washing machine housing, a drain device 70, 70a configured to discharge water from the tub to outside of the washing machine housing, and a filter apparatus 100 to be disposed outside the washing machine housing and connectable to the drain device. The filter apparatus comprises a filter case 110, a filter 120 coupleable to and decoupleable from the filter case, and a filter cleaning device 130 configured to clean the filter. The filter cleaning device comprises a cleaning driving device 135 mountable in the filter case, a blade bracket 133 couplable to and decoupleable from the cleaning driving device, the blade bracket including a portion 133b that is deformable while the blade bracket is decoupled from the cleaning driving device, and a blade 132 detachably couplable to the blade bracket. Accordingly, the filter apparatus 100 according to an embodiment may facilitate maintenance and/or repair of the cleaning member 131.

The blade may include a material that is more flexible than the blade bracket.

The blade bracket may include a coupling guide 133c whose position changes as the deformable portion is deformed. The cleaning driving device may include a guide coupling portion 137b that is couplable with the coupling guide 133c.

The coupling guide may be configured to be deformable by the cleaning driving device while the cleaning member is being coupled to the cleaning driving device.

The deformable portion may be configured to be accessible when the filter is removed from the filter case.

The deformable portion may be located at an end opposite to an end connected to the cleaning driving device.

According to a concept of the present disclosure, the clothes treating apparatus can be easily managed because the filter apparatus is disposed outside the washing machine.

According to the concept of the present disclosure, since the filter apparatus includes a filter cleaning device, the filter replacement cycle can be increased.

According to the concept of the present disclosure, since the filter apparatus and the clothes treating apparatus having the filter apparatus include the remaining water guide, it is possible to prevent contamination of the surroundings of the filter apparatus while managing the filter.

According to the concept of the present disclosure, since the filter apparatus includes a bypass flow path, water can be discharged from the filter apparatus even if a part of the filter is clogged.

According to the concept of the present disclosure, since the filter apparatus and the clothes treating apparatus having the filter apparatus include a bypass flow path, even if a part of the filter is clogged, the operation can be prevented from being stopped.

Effects that may be achieved by the disclosure are not limited to the above-mentioned effects, and other effects not mentioned will be clearly understood by one of ordinary skill in the technical field to which the disclosure belongs from the following descriptions.

So far, specific embodiments have been shown and described. However, the disclosure is not limited to these embodiments, it should be interpreted that various modifications may be made by one of ordinary skill in the technical art to which the disclosure belongs, without deviating from the gist of the technical concept of the disclosure, which is defined in the following claims.

1. A filter apparatus, to be disposed outside a washing machine, connectable to a drain device of the washing machine, the filter apparatus comprising:
a filter case;
a filter coupleable to and decoupleable from the filter case; and
a filter cleaning device configured to clean the filter,
wherein the filter cleaning device includes:
a cleaning driving device mountable in the filter case; and
a cleaning member couplable to and decoupleable from the cleaning driving device, the cleaning member including a portion configured to be deformable while the cleaning member is decoupled from the cleaning driving device.

2. The filter apparatus of claim 1, wherein
the cleaning member comprise:
a blade bracket including the portion and configured to be coupled to the cleaning driving device; and
a blade couplable to the blade bracket and including a material more flexible than the blade bracket.

3. The filter apparatus of claim 2, wherein
the blade bracket includes a coupling guide configured to change position as the portion deforms, and
the cleaning driving device includes a guide coupling portion couplable to the coupling guide.

4. The filter apparatus of claim 3, wherein
the coupling guide is deformable by the cleaning driving device while the cleaning member is being coupled to the cleaning driving device, and is configured to be restored when the cleaning member is coupled to the cleaning driving device.

5. The filter apparatus of claim 3, wherein
the blade bracket includes a guide slope provided in the coupling guide, the guide slope being configured to guide deformation of the portion while the cleaning member is being coupled to the cleaning driving device.

6. The filter apparatus of claim 3, wherein
the blade bracket includes a reduced portion positioned adjacent to the coupling guide.

7. The filter apparatus of claim 2, wherein
the cleaning driving device comprises:
a cleaning motor; and
a motor shaft coupled to the blade bracket to transmit a driving force of the cleaning motor to the blade bracket, the motor shaft including a material having greater rigidity than the blade bracket.

8. The filter apparatus of claim 1, wherein
the portion is located at an end of the cleaning member opposite to an end connected to the cleaning driving device.

9. The filter apparatus of claim 1, wherein
the cleaning driving device includes a shaft slope configured to guide deformation of the portion while the cleaning member is being mounted.

10. The filter apparatus of claim 1, wherein
the portion is configured to be accessible when the filter is separated from the filter case.

11. The filter apparatus of claim 1, wherein
the portion includes an elastic material configured to allow deformation and restoration.

12. The filter apparatus of claim 1, wherein
the cleaning member is configured to contact an inner circumferential surface of the filter.

13. The filter apparatus of claim 1, wherein
the cleaning member includes a blade integrally formed with the portion.

14. The filter apparatus of claim 1, wherein
the cleaning member comprises:
a blade bracket screwed to the cleaning driving device; and
a blade coupled to the blade bracket and including a material more flexible than the blade bracket.

15. A clothes treating apparatus comprising:
a washing machine including a washing machine housing, a tub to be provided inside the washing machine housing, a drain device configured to discharge water from the tub to outside of the washing machine housing; and
a filter apparatus to be disposed outside the washing machine housing and connectable to the drain device,
wherein the filter apparatus comprises:
a filter case;
a filter coupleable to and decoupleable from the filter case; and
a filter cleaning device configured to clean the filter,
wherein the filter cleaning device comprises:
a cleaning driving device mountable in the filter case;
a blade bracket couplable to and decoupleable from the cleaning driving device, the blade bracket including a portion that is deformable while the blade bracket is decoupled from the cleaning driving device; and
a blade detachably couplable to the blade bracket.
